(19) United States
(12) Patent Application Publication
(10) Pub. No.: US 2009/0102791 A1
(43) Pub. Date: Apr. 23, 2009

(54) Pointing Device Covering

(76) Inventor: Thomas D. Mote, Spring, TX (US)

Correspondence Address: ARNOLD & KNOBLOCH, L.L.P., 2401 FOUNTAIN VIEW DRIVE, SUITE 630, HOUSTON, TX, 77057, US

(21) Appl. No.: 12/256,396

(22) Filed: Oct. 22, 2008

Related U.S. Application Data
(60) Provisional application No. 60/981,834, filed on Oct. 23, 2007.

(51) Int. Cl. G06F 3/033

(52) U.S. Cl. 345/163

(57) ABSTRACT

A pointing device cover having a topside and an underside having a hollowed-out area for receiving the pointing device. A pressure zone and a fidgeting member are disposed on the topside. The cover is formed of a unitary rubbery material and the pressure zone enables actuation of a button on the pointing device. In one example, a cloth cover-up overlays at least a portion of the topside.

### FIELD OF THE INVENTION

This invention relates to a pointing device, in particular example, to a computer mouse.

### BACKGROUND OF THE INVENTION

Pointing devices, such as a computer mouse, typically create hand fatigue during extended periods of use. It is believed that the disciplined, rigid positioning of the hand on these pointing devices leads to various discomforts, ailments, or syndromes. Such pointing devices are typically made of hard plastic, providing no opportunity to exercise the hand or depart from the rigid positioning of the hand during use of the device. A basic problem is that positioning and control of the pointing device is lost if the hand deviates from the hand's rigid holding of the pointing device.

It is felt that a pointing device which has a flexible, gummi, or otherwise rubbery topside provides opportunity for exercise of the hand while at the same time maintaining positioning and control of the pointing device. Further, opportunity should be given to the hand to perform small exercise movements while maintaining positioning and control of the pointing device. Further, providing an attractive nuisance for performing such exercise movements would help remind the user to perform the small movement exercises.

### SUMMARY OF THE INVENTION

In an example, a pointing device cover is provided, the pointing device cover including: pressure access to mouse buttons; a rubbery topside; and a fidgeting member disposed thereon. In a further example, an underside cavity is disposed on the pointing device cover to fittably receive a computer mouse.

In an example, a pointing device cover is provided, the pointing device cover including a flexible, gummi, or otherwise rubbery topside that provides opportunity for exercise of the hand while at the same time maintaining positioning and control of a pointing device. In a further example, the pointing device cover includes a topside pressure zone for depressing mouse buttons of the pointing device. In a further example, the pointing device cover includes a fidgeting member disposed thereon, the fidgeting member providing opportunity to a user's hand to perform small exercise movements while maintaining positioning and control of the pointing device. In a further example, the fidgeting member has an appearance and/or shape of a flexible nipple, providing an attractive nuisance to assist in reminding the user to perform the small movement exercises.

In another example, a pointing device cover is provided. This cover provides a softer, oversized grip for a computer mouse. The design appears to be a ladies breastform, but it actually incorporates a standard, mini-mouse, or joystick type of computer pointing device inside. The cover is soft and pliable enough to allow clicking of the standard mouse keys through the soft surface, providing a more stimulating interface between the user and the computer. The appearance approximates a lifelike representation of a female breast, while offering a more entertaining way for a user to grip a computer's pointing device.

In another example, the standard “Mouse Upgrade”, pointing device cover, is a silicone or urethane filled breastform that appears teardrop shaped when viewed from directly above, with a hollowed-out area inside or underneath to hold the mouse in place. The breastform is also called a “Mouse Upgrade Cover.” When viewed from above, the Mouse Upgrade Cover is a lifelike three-dimensional model of a breastform on the user's mousepad. A user's hand falls naturally in place, the mouse buttons are just below the soft pliable surface, and respond normally when clicked, or double-clicked. The natural “rebound” of the cover material does nothing to obstruct or hinder the mouse's normal clicking operations.

In another example, the mouse of preference is typically a wireless mouse, or any mini-mouse of the type readily available in retail stores and subject to new upgrades, as new models come out daily, so the number of possibilities is virtually unlimited.

In another example, one version includes a wired, or wireless mini mouse molded within, and, if wireless, is packaged with a small USB transmitter tuned to send and receive signals from the enclosed pointing device, the mouse.

In other examples, models are upgradeable to include new technology advances, like laser, Bluetooth, etc.

In another example, the pointing device cover works equally with wired or wireless mice.

In another example, a “Custom Application” includes a cover made specifically to fit over an existing alternative type of mouse pointer device, and the cover designs follow mouse styles in the future.

In another example, a selection of pointing device covers enable change in size to larger or smaller. In a further example, a selection of pointing device covers emulate bra cup sizes, for example A, B, C, D, etc.

In another example, a selection of pointing device covers enable change in color. Any shade of the color spectrum is possible, but typically lifelike colors would be first to be offered.

In another example, the pointing device cover glows in the dark. In another example the pointing device cover further includes a built in mini light.

In another example, the pointing device cover is packaged to include a piece of soft stretchy cloth to cover up the nipple area and lower/fatter portion of the pointing device cover, a sort of “Modest Cover-up” or bra covering.

In another example, an elastic band secures the bra covering in place, over the fattest area of the top of the pointing device cover, and around underneath the pointing device cover, leaving a window, hole, or aperture for the optical reader of the mouse to communicate with, or otherwise sense, the mouse pad.

Knowing that some users will prefer the feel of the mouse with the bra covering left off and that some users will prefer the bra covering in place, in a further example, the bra covering is detachable. In an alternate example, the bra covering is not detachable.

In another example, the pointing device cover is molded in a way to grip the mouse up inside, as well as underneath.

In another example, the mouse can be glued in place.

In another example, there must be an area beneath the pointing device cover that is left open, or transparent, like a window, in order to allow the enclosed mouse to track and, continue to work as an ordinary mouse.

In another example, the decorative “Cover-ups,” bra coverings are offered with professional, or college sports, company, or team logos.

In another example, the decorative “Cover-ups,” bra coverings display advertisements. In a further example, the bra coverings display advertisements for adult entertainers.

In another example, the pointing device cover is molded to emulate or model a breast from an actual person. In such example, a mold of a specific woman's breast and cast of a life size copy is made to fulfill special order or production run.

In another example, the pointing device cover includes surface coverings selected from urethane, soft latex, or any variation of skin-like materials.

In another example, the pointing device cover includes surface coverings composed of neoprene with fabric surface skin, like mouse pads or like diver suits are made of.

In another example, the pointing device cover includes surface coverings composed of a suede-like surface.

In another example, the pointing device cover includes surface coverings composed of velvet.

In another example, the pointing device cover includes surface coverings composed of velour.

In another example, the pointing device cover includes surface coverings composed of leather.

In another example, the pointing device cover includes surface coverings composed of rubber.

In another example, the pointing device cover includes surface coverings composed of stretchy latex.

In another example, the pointing device cover is used to provide orthopedic benefits owing to the use of the larger, more pliable mouse.

In another example, the pointing device cover is used to research whether the onset of carpal tunnel syndrome may be delayed.

In another example, the pointing device cover is used to provide therapeutic benefits owing to the use of the larger softer mouse.

In another example, the pointing device cover is used to provide enhanced enjoyment for Video Gamers and Virtual Reality players, noting that additional buttons will still work with these covers on them.

In another example, a pointing device cover is provided, the pointing device cover integrated as the top cover portion of the pointing device.

In another example, a pointing device cover is provided, further including a computer-mouse tracking sensor, the tracking sensor and associated electronics embedded within the flexible, gummi, or otherwise rubbery composition of the pointing device cover.

In another example, a pointing device cover is provided, wherein simulation of a breast is not required, the pointing device cover including: a means for exercising a hand while operating the pointing device and a means for exercising by small hand or finger movement. In a further example, the pointing device cover further includes a means for promoting exercise movements. In a particular example, the means for exercising a hand while operating the pointing device includes a flexible, gummi, or otherwise rubbery topside for the pointing device cover. In a particular example, the means for exercising by small hand or finger movement includes a fidgeting member disposed on the pointing device cover. In a particular example, the means for promoting exercise movements includes an attractive nuisance. In a particular example, the attractive nuisance is a flexible protrusion or nipple.

### SUMMARY OF THE SEVERAL VIEWS

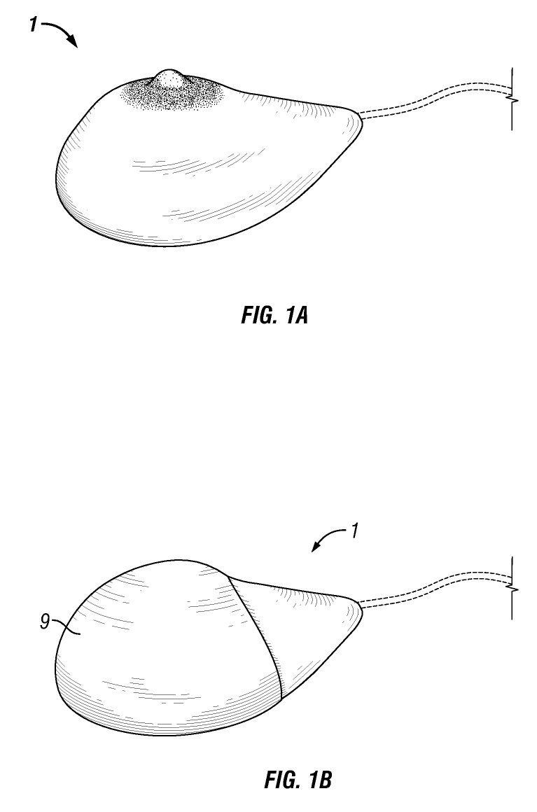

FIG. 1A illustrates a 3-D perspective view and example of the pointing device covering 1.

FIG. 1B illustrates a 3-D perspective view and example of the pointing device covering 1, with a bra covering 9.

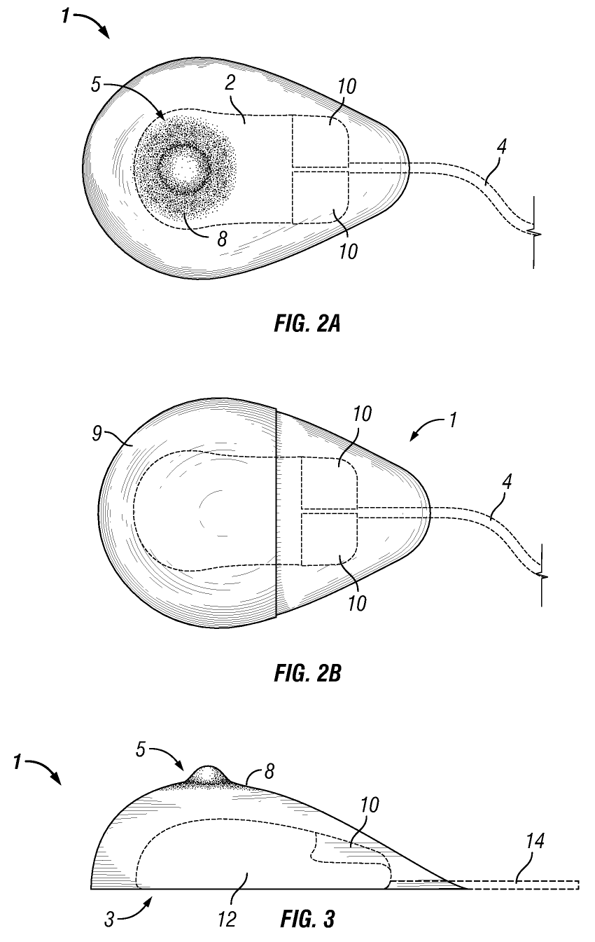

FIG. 2A illustrates a top view and example of the pointing device covering 1.

FIG. 2B illustrates a top view and example of the pointing device covering 1, with a bra covering 9.

FIG. 3 illustrates a side view and example of the pointing device covering 1.

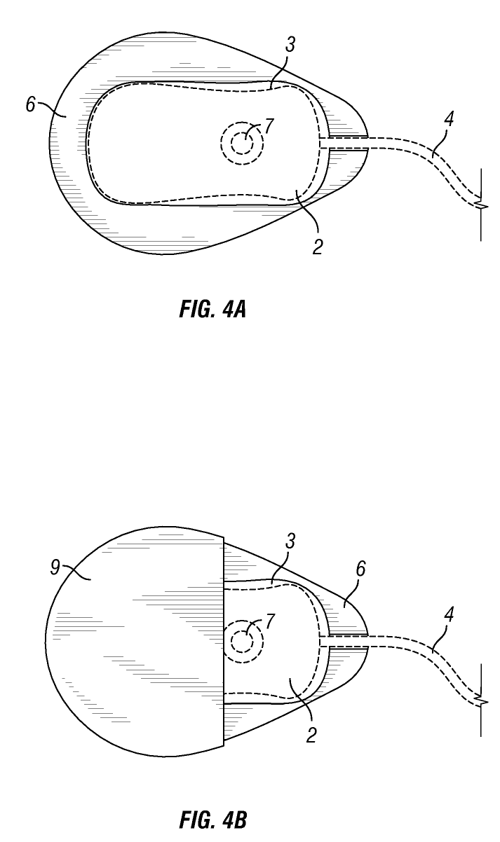

FIG. 4A illustrates a bottom view and example of the pointing device covering 1.

FIG. 4B illustrates a bottom view and example of the pointing device covering 1, with a bra covering 9.

| | |
|---|---|
| 1: Soft Cover, pointing device covering | 2: Embedded “Mouse,” or |
| | “Pointing device.” |
| 3: Cavity molded to receive & hold | 4: Mouse Cable, (Optional) |
| Mouse 2 | |
| 5: Nipple, design detail | 6: Smooth underside |
| 7: Optical Sensor, Laser Sensor, or | 8: Nipple aureole, design detail |
| Mouse tracking ball | |
| 9: “Bra” cover, bra covering | 10: Pressure zone for depressing |
| | mouse buttons |

### DETAILED DESCRIPTION OF EXAMPLES OF THE INVENTION

In an example of the invention, this device is a soft pliable, life sized breast-like, decorative cover upgrade for a computer mouse. The device appears like a human female breast, in a “1 to 1 ratio” for a lifelike presentation. The device generally follows the teardrop shape favored by breastform manufacturers, currently manufacturing breastforms as figure enhancers, and/or similar prosthetic devices, except that a hollowed out portion underneath houses an actual computer mouse, or joystick pointing device.

FIG. 1A illustrates an angled, overhead view of the “Better Mouse,” pointing device covering 1. It appears as a life like female breast, with or without a cable 4. Pointing device covering 1 has a topside that is rubbery.

FIG. 1B illustrates an angled, overhead view of the “Better Mouse,” covering 1 with a “Bra”, bra covering 9 partially covering it up. In a further example, not illustrated, bra covering 9 may cover covering 1 more or less than presently illustrated. In a further example, not illustrated, bra covering 9 may, more or less, completely cover covering 1.

FIG. 2A illustrates an overhead view of the “Better Mouse,” covering 1 showing, aureole 8 area having a darker coloring, and a slightly different texture, in order to more closely resemble a real breast. The positioning of the mouse 2 is forward and close enough to the top surface to allow minimal coverage, creating a pressure zone 10 for depressing mouse buttons, and consequently better responsiveness to tapping over the mouse buttons in the two areas, zones 10, directly above them. Zones 10 provide pressure access to mouse buttons.

FIG. 2B illustrates an overhead view depicts the “Better Mouse,” covering 1, showing the approximate positioning of the “Bra” bra covering 9 cover, in place. In a further example, not illustrated, bra covering 9 may cover covering 1 more or less than presently illustrated. In a further example, not illustrated, bra covering 9 may, more or less, completely cover covering 1.

FIG. 3 illustrates a side view illustration of the “Better Mouse,” covering 1, depicting the embedded mouse 2, represented by broken lines, inside covering 1. The cavity 3 is molded to a fittable size of the mouse 2 in order to hold mouse 2 securely in place. Cable 4 extends from the front of “Better Mouse,” covering 1, depicting a typical location for the Cable 4. Nipple 5 is disposed on Better Mouse,” covering 1, showing the raised appearance of the nipple 5 when viewed from this angle. Nipple 5 is one example of a fidgeting member disposed on covering 1, providing an exercise and/or circulation-enhancement point for stimulating hand movement. By placing the mouse 2 forward in the covering 1, the mouse buttons are situated close enough to the surface to allow them to respond, whenever the key areas, zones 10 are tapped, or depressed.

FIG. 4A illustrates the “Better Mouse”, covering 1, from below, with a detail showing, the actual mouse 2, or pointing device, as it nests inside the specially molded cavity 3 with a relief for the optional cable 4, in the bottom, smooth surface 6 of the “Better Mouse,” covering 1. An optical, laser, or ball tracking device 7 is disposed on mouse 2, allowing the mouse 2 to communicate with the mouse pad environment.

FIG. 4B illustrates the “Better Mouse”, covering 1, from below, with the “Bra”, bra covering 9 in place, leaving the tracking device 7 exposed to communicate with the mouse pad environment.

In one specific example, the pointing device cover is made from a unitary elastomeric urethane material prepared by mixing urethane prethane, sold under the trade name PCDD100 (distributed by Hisco/Precision Converting), parts A and B, prethane urethane elastomer plasticizer D.I.D.P., and silicone powder sold under the trade name AEROSIL® R-812 (Manufactured by Evonik Industries) and dispensing those materials into a negative mold in the desired form. In a further example, the plasticizer is mixed into part B of the urethane prethane in a ratio between 0.35:1 and 0.60:1 and the silicone powder is mixed into part B of the urethane prethane in a ratio between 0.01:1 and 0.02:1. In still a further example, these components are dispensed into a mold using a variable ratio rapid prototyping machine such as that sold under the trademark Posiratio® Mini-RPV or similar. In still a further example, these components are automatically, and hydraulically dispensed through a static mixer sold under the trade name STATOMIX®, 10 mm×32 elements, 14″ length nozzle tip, made by Sulzer Ltd.

In another example, the negative mold is made of a silicone or urethane mold that is harder than the material being produced. In a further example, the hollowed-out area for receiving the pointing device is achieved by bridging a hard plastic dummy or positive mold across the negative cover mold so that it leaves a hole just deep enough to accept the pointing device, while leaving it exposed on the bottom enough to interface with a standard mouse pad. In still a further example, the mixture described above is dispensed into the mold around the pointing device shaped dummy. In still a further example, a urethane releasing agent, such as that sold under the trade name Camie® 980 (made by Camie-Campbell, Inc.) is lightly sprayed on all the molds to avoid sticking.

Accordingly, I have invented a new and non-obvious device for enhancing a pointing device. Further, the new device provides hand exercise and stimulation for both work and play. Still further, the new device is usable by others and may be used for other purposes.

Various aspects of the invention, including alternative embodiments and the various functionalities associated therewith, are disclosed with particularity in the attached drawing sheets, FIGS. 1-4B. I submit that those of ordinary skill in the art will recognize and be able to appreciate the advantages of the apparatus, along with its associated methods and/or resulting systems.

Thus, the foregoing description is presented for purposes of illustration and description, and is not intended to limit the invention to the forms disclosed herein. Consequently, variations and modifications commensurate with the above teachings and the teaching of the relevant art are within the spirit of the invention. Such variations will readily suggest themselves to those skilled in the relevant structural or mechanical art. Further, the embodiments described are also intended to explain the best mode for practicing the invention, and to enable others skilled in the art to utilize the invention and such or other embodiments and with various modifications required by the particular applications or uses of the invention. It is intended that the appended claims be construed to include alternative embodiments to the extent that is permitted by prior art.

I claim:

1. A cover for a pointing device for a computer comprising:
a topside;
an underside having a hollowed-out area for receiving the pointing device;
a pressure zone disposed on the topside;
a fidgeting member disposed on the topside;
wherein the cover is comprised of a unitary rubbery material; and
wherein the pressure zone enables actuation of a button on the pointing device.

2. The pointing device cover of claim 1, wherein the fidgeting member is a flexible nipple.

3. The pointing device cover of claim 2, wherein the fidgeting member is a lifelike three-dimensional representation of a female nipple.

4. The pointing device cover of claim 3, wherein the cover is a lifelike three-dimensional representation of a female breast.

5. The pointing device cover of claim 4, wherein the rubbery material is elastically deformable and resilient, whereby the cover has a lifelike feel.

6. The pointing device cover of claim 5, wherein the hollowed out area is custom shaped to fit an existing pointing device.

7. The pointing device cover of claim 5, wherein the cover is a lifelike color.

8. The pointing device cover of claim 5, wherein the cover glows in the dark.

9. The pointing device cover of claim 5, wherein the cover is translucent enabling transmission of light from the pointing device to the topside of the cover.

10. The pointing device cover of claim 5, wherein the cover is molded directly on the pointing device.

11. The pointing device cover of claim 5, further comprising a cloth cover-up disposed on at least a portion of the topside.

12. The pointing device cover of claim 11, wherein the cloth cover-up is comprised of a stretchy material.

13. The pointing device cover of claim 11, wherein the cover-up covers the topside.

14. The pointing device cover of claim 13, wherein the cover-up comprises a representation of a part of a bathing suit.

15. The pointing device cover of claim 13, wherein the cover-up comprises a representation of a part of an undergarment.
